(19) United States
(12) Patent Application Publication
(10) Pub. No.: US 2024/0170975 A1
(43) Pub. Date: May 23, 2024

(54) METHOD, SYSTEM, DEVICE AND MEDIUM FOR RECHARGING BATTERY MODULE

(71) Applicant: Shanghai Makesens Energy Storage Technology Co., Ltd., Shanghai (CN)

(72) Inventors: Peng DING, Shanghai (CN); Xiao YAN, Shanghai (CN); Enhai ZHAO, Shanghai (CN); Qiqi YIN, Shanghai (CN); Haowen REN, Shanghai (CN); Yuan FENG, 201612 (CN); Weikun WU, Shanghai (CN); Decheng WANG, Shanghai (CN)

(73) Assignee: Shanghai Makesens Energy Storage Technology Co., Ltd., Shanghai (CN)

(21) Appl. No.: 18/513,615

(22) Filed: Nov. 19, 2023

(30) Foreign Application Priority Data
Nov. 21, 2022 (CN) 2022114612756

(51) Int. Cl. H02J 7/00

(52) U.S. Cl. CPC H02J 7/0013; H02J 7/0048

(57) ABSTRACT

A method, system, device, and medium for recharging a battery module are disclosed. The method comprises: identifying initial rechargeable batteries within the battery module; selecting from the initial rechargeable batteries, a reference rechargeable battery that satisfies preset charging and discharging conditions, and designating the remaining batteries of the initial rechargeable batteries as target rechargeable batteries; and determining a target capacity for each of the target rechargeable batteries based on the historical charging and discharging parameters of the reference rechargeable battery and each of the target rechargeable batteries; establishing a recharge termination condition for each of the target rechargeable batteries based on the target capacity; and recharging each of the target rechargeable batteries in accordance with its respective recharge termination condition. Considering the unique conditions of each battery, settings for recharge are individualized. The method optimizes the recharging strategy, reduces recharging time, and maximizes capacity of the battery module.

### CROSS REFERENCE TO RELATED APPLICATION

The present application claims the benefit of priority to Chinese Patent Application No. CN 202211461275.6, entitled “method, system, device and medium for recharging battery module”, filed with CNIPA on Nov. 21, 2022, the disclosure of which is incorporated herein by reference in its entirety for all purposes.

### FIELD OF THE INVENTION

The present disclosure generally relates to the field of battery management technology, and in particular to a method, system, device and medium for recharging a battery module.

### BACKGROUND OF THE INVENTION

Power batteries in electric vehicles and energy storage batteries in energy storage stations have become widely adopted. To cater to the capacity and power demands of various applications, batteries are arranged in series or parallel or some combinations to form a battery module, to provide a necessary capacity.

However, during usage, due to differences in manufacturing and operating conditions, the batteries may develop inconsistencies in capacity. This inconsistency can lead to voltage stratification in the individual batteries during their charging and discharging process. Following the principle of the “barrel effect”, the total output of a battery module is determined by the battery with the lowest capacity. Therefore, after a certain period of use, it becomes necessary to recharge the battery module.

Existing methods to cope with the variations involve recharging each individual battery meanwhile having all batteries go through the same charge termination condition, and an external charging device is used to charge the batteries that are not fully charged, until all batteries reach the charge termination condition, thereby completing equalization recharging of the battery module. However, the existing methods have drawbacks. For example, after recharging, due to the inconsistent voltage and capacity of each individual battery, some batteries may not be able to fully discharge. Moreover, because the recharging current of the existing methods is small, recharging can take days, hindering effective utilization of the battery module's capacity, severely impacting the normal operation and maintenance of the power station.

### SUMMARY OF THE INVENTION

In light of shortcomings of existing technologies where the same recharge termination condition is used for different batteries within one battery module, resulting in a long recharge time, ineffective utilization of the battery module's capacity, and a low efficiency of the operation and maintenance of the power station. the present disclosure provides a method, system, device and medium for recharging a battery module.

A first aspect of the present disclosure provides a method for recharging a battery module, comprising: identifying initial rechargeable batteries within the battery module; selecting, from the initial rechargeable batteries, a reference rechargeable battery that satisfies preset charging and discharging conditions, and designating remaining batteries of the initial rechargeable batteries as target rechargeable batteries; determining a target capacity for each of the target rechargeable batteries based on historical charging and discharging parameters of the reference rechargeable battery and each of the target rechargeable batteries; establishing a recharge termination condition for each of the target rechargeable batteries based on its respective target capacity; and recharging each of the target rechargeable batteries in accordance with its respective recharge termination condition.

Preferably, identifying the initial rechargeable batteries within the battery module comprises: obtaining the historical charging and discharging parameters of each battery within the battery module; and determining, based on the historical charging and discharging parameters, whether there is a first battery within the battery module which first reaches charge termination and also first reaches discharge termination; if yes, replacing the first battery; if not, determining that the first battery is one of the initial rechargeable batteries.

Preferably, selecting from the initial rechargeable batteries, the reference rechargeable battery, comprises: based on the historical charging and discharging parameters of each of the initial rechargeable batteries, determining on a battery among the initial rechargeable batteries that if the battery first reaches charge termination but does not first reach discharge termination and designating the battery as the reference rechargeable battery.

Preferably, when the target capacity comprises a chargeable capacity, determining the target capacity for each of the target rechargeable batteries comprises: obtaining a charge termination voltage and a charge termination moment corresponding to when the reference rechargeable battery reaches the charge termination; obtaining a first charging voltage of the target rechargeable battery at the charge termination moment of the reference rechargeable battery; obtaining a first charging moment of the target rechargeable battery corresponding to the first charging voltage; obtaining a charging current of the target rechargeable battery between the first charging moment of the target rechargeable battery and the charge termination moment of the reference rechargeable battery; and based on the first charging moment, the charge termination moment, and the charging current, calculating a chargeable capacity of the target rechargeable battery.

Preferably, for each of the target rechargeable batteries, when the target capacity comprises a dischargeable capacity, determining the target capacity for each of the target rechargeable batteries comprises: obtaining a discharge termination voltage and a discharge termination moment corresponding to when this target rechargeable battery reaches discharge termination; obtaining a first discharge voltage of the reference rechargeable battery at the discharge termination moment; determining whether the discharge termination voltage is greater than the first discharge voltage; if not, obtaining a first discharge moment of the target rechargeable battery corresponding to the first discharge voltage; obtaining a discharge current of the target rechargeable battery between the first discharge moment and the discharge termination moment of the target rechargeable battery; and based on the first discharge moment, the discharge termination moment, and the discharge current, calculating a dischargeable capacity of the target rechargeable battery.

Preferably, the chargeable capacity of the target rechargeable battery is given by:

Qc=∫ₜ₁^{t2}Idt≈Σₖ₌₁ⁿΔtₖIₖ,

wherein Qc denotes the chargeable capacity of the target rechargeable battery, t1 denotes the first charging moment of the target rechargeable battery, t2 denotes the charge termination moment of the reference rechargeable battery, I denotes the charging current, wherein a first total time interval between t1 and t2 is discretized into n portions based on a first sampling frequency, wherein Iₖ denotes the charging current corresponding to a kth portion, and Δtₖ denotes a first subsidiary time interval corresponding to the kth portion; wherein the dischargeable capacity of the target rechargeable battery is given by:

Qd=∫ₜ₃^{t4}I′dt≈Σ_{f=1}^{m}Δt_{f}I_{f},

wherein Qd denotes the dischargeable capacity of the target rechargeable battery, t3 denotes the first discharge moment, t4 denotes the discharge termination moment of the target rechargeable battery, I′ denotes the discharge current, and wherein a second total time interval between t3 and t4 is discretized into m portions according to a second sampling frequency, I_{f} denotes the discharge current corresponding to a fth portion, and Δt_{f} denotes a second subsidiary time interval corresponding to the fth portion.

Preferably, establishing the recharge termination condition for each of the target rechargeable batteries based on the target capacity comprises: determining whether the dischargeable capacity of the target rechargeable battery is less than or equal to the chargeable capacity of same target rechargeable battery; if yes, setting the chargeable capacity of the target rechargeable battery as a recharge termination condition of the target rechargeable battery; and if not, setting the charge termination voltage as the recharge termination condition of the target rechargeable battery.

Preferably, the charge termination comprises a full-charge state and a discharge termination comprises a full-discharge state.

A second aspect of the present disclosure provides a recharge system for a battery module, comprising: a battery identification module, for identifying initial rechargeable batteries within the battery module; a battery selection module, for selecting, from the initial rechargeable batteries, a reference rechargeable battery that satisfies preset charging and discharging conditions, and for designating remaining batteries among the initial rechargeable batteries as target rechargeable batteries; a capacity determination module, for determining a target capacity for each of the target rechargeable batteries based on historical charging and discharging parameters of the reference rechargeable battery and each of the target rechargeable batteries; a recharge-condition establishment module, for establishing a recharge termination condition for each of the target rechargeable batteries based on the target capacity; and a recharge control module, for recharging each of the target rechargeable batteries in accordance with its respective recharge termination condition.

A third aspect of the present disclosure provides an electronic device, comprising a memory, a processor and a computer program stored on the memory and executable by the processor, wherein the processor executes the computer program to implement a method according to any one of the embodiments provided in the first aspect.

A fourth aspect of the present disclosure provides a non-transitory computer-readable storage medium, storing a computer program, wherein when the computer program is executed by a processor, a method according to any one of the embodiments provided in the first aspect is implemented.

Advantages of the present disclosure are the following:

The present disclosed method, system, device, and medium for recharging a battery module work by selecting a reference rechargeable battery and target rechargeable batteries from a battery module, obtaining a target capacity corresponding to each of the target rechargeable batteries based on historical charging and discharging parameters of the reference rechargeable battery and the target rechargeable batteries, and then deriving a recharge termination condition corresponding to each of the target rechargeable batteries. By considering the unique conditions of each battery, the present disclosure can individualize the settings for the recharge termination conditions. The present disclosure optimizes the recharging strategy, reducing the time needed for recharging the battery module. Moreover, it enhances the capacity of the battery module after the equalization recharging, maximizing its capacity and improving the efficiency of the operation and maintenance of the power station.

### BRIEF DESCRIPTION OF THE DRAWINGS

FIG. 1 is a first flowchart illustrating a method for recharging a battery module according to Embodiment 1 of the present disclosure;

FIG. 2 is a second flowchart illustrating the method for recharging the battery module according to Embodiment 1 of the present disclosure;

FIG. 3 shows a chart for historical charging and discharging parameters of the battery module according to Embodiment 1 of the present disclosure;

FIG. 4 is a third flowchart illustrating the method for recharging the battery module according to Embodiment 1 of the present disclosure;

FIG. 5 shows a first chart for historical charge and discharge parameters of initial rechargeable batteries according to Embodiment 1 of the present disclosure;

FIG. 6 is a fourth flowchart illustrating the method for recharging the battery module according to Embodiment 1 of the present disclosure;

FIG. 7 shows a second chart for the historical charging and discharging parameters of the initial rechargeable batteries according to Embodiment 1 of the present disclosure;

FIG. 8 shows a third chart for the historical charge and discharge parameters of the initial rechargeable batteries according to Embodiment 1 of the present disclosure;

FIG. 9 is a block diagram of a system for charging a battery module according to Embodiment 2 of the present disclosure;

FIG. 10 is a block diagram of an electronic device according to Embodiment 3 of the present disclosure.

### DETAILED DESCRIPTION

The present disclosure is further described below by way of embodiments, without thereby limiting the present disclosure to the scope of the described embodiments.

### Embodiment 1

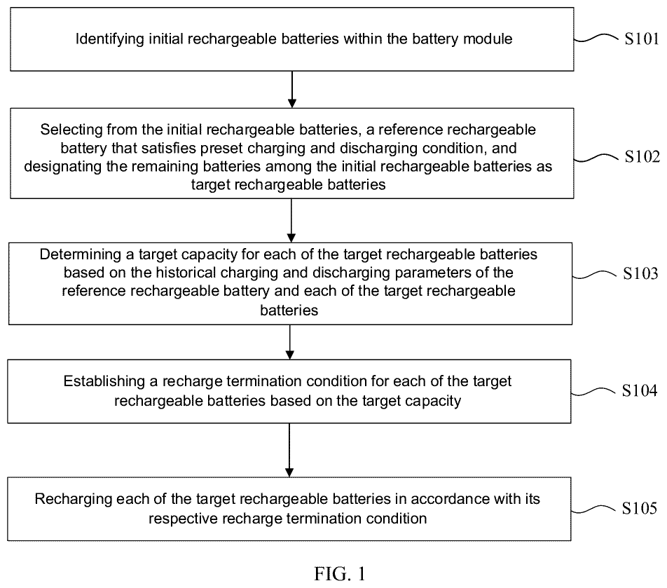

Embodiment 1 provides a method for recharging a battery module; as shown in FIG. 1, the method for recharging the battery module comprises:
S101: identifying initial rechargeable batteries within the battery module;

The battery module consists of several batteries, and after a period of use, the individual batteries may develop inconsistencies in capacity, where some batteries need recharging and some don't, and therefore it is necessary to first obtain a number of initial rechargeable batteries within the battery module. The initial rechargeable batteries are batteries that need recharging.

Herein, the process of recharging can also be described as equalization recharging, which allows the capacity deviation of each individual batteries within the battery module to remain within a predetermined range. As a result, the capacity of the entire battery module is enhanced after recharging, thereby achieving maximum efficiency.
S102: selecting from the initial rechargeable batteries, a reference rechargeable battery that satisfies preset charging and discharging condition, and designating the remaining batteries among the initial rechargeable batteries as target rechargeable batteries;
S103: determining a target capacity for each of the target rechargeable batteries based on the historical charging and discharging parameters of the reference rechargeable battery and each of the target rechargeable batteries;

Specifically, the target capacity for each of the target rechargeable batteries relative to the reference rechargeable battery is obtained using the reference rechargeable battery as a reference.
S104: establishing a recharge termination condition for each of the target rechargeable batteries based on the target capacity; and

Since each of the target rechargeable batteries has its own corresponding target capacity, an individualized setting of the recharge termination condition is achieved with respect to the target capacity of each of the target rechargeable batteries.
S105: recharging each of the target rechargeable batteries in accordance with its respective recharge termination condition.

The present disclosed method for recharging a battery module work by selecting a reference rechargeable battery and target rechargeable batteries from a battery module, obtaining a target capacity corresponding to each of the target rechargeable batteries based on their historical charging and discharging parameters of the reference rechargeable battery and the target rechargeable batteries, and then deriving a recharge termination condition corresponding to each of the target rechargeable batteries. By taking into account the unique conditions of each battery, the present disclosed method can individualize the settings for the recharge termination condition. The present disclosed method optimizes the recharging strategy, reducing the time needed for recharging the battery module. Moreover, it enhances the capacity of the battery module after the equalization recharging, maximizing its capacity and improving the efficiency of the operation and maintenance of the power station.

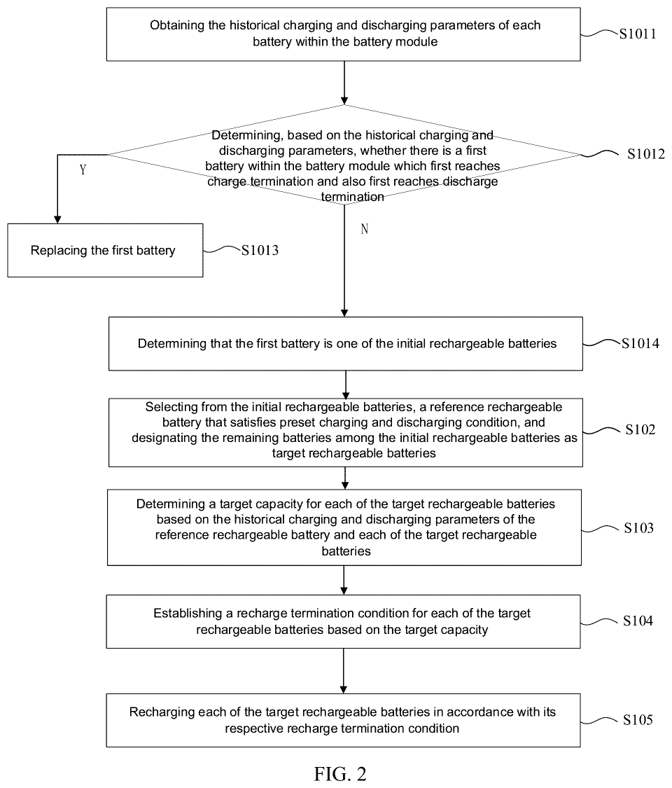

As an example, as shown in FIG. 2, step S101 comprises:
S1011: obtaining the historical charging and discharging parameters of each battery within the battery module;

The historical charging and discharging parameters comprise battery recharge data, such as charging and discharging time, charging and discharging currents, and charging and discharging voltages, for at least one complete charging and discharging cycle.
S1012: determining, based on the historical charging and discharging parameters, whether there is a first battery within the battery module which first reaches charge termination and also first reaches discharge termination;

If yes, step S1013 is performed; if not, step S1014 is performed.
S1013: replacing the first battery.

If a battery first reaches charge termination and also first reaches discharge termination, that means it does not need recharging, and there is no need for equalization recharge, and therefore batteries like this are directly replaced.
S1014: determining that the first battery is one of the initial rechargeable batteries.

If a battery does not first reach charge termination and first reach discharge termination, this battery is designated as one of the initial rechargeable batteries, and needs recharging.

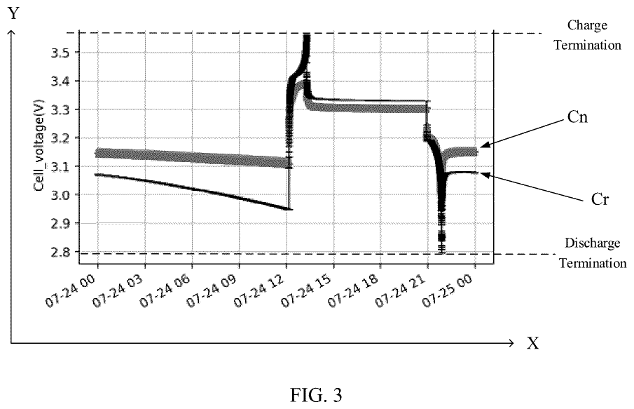

FIG. 3 shows a chart for the historical charging and discharging parameters of the battery module according to Embodiment 1, these cell voltage-vs-time data points reveal the charging and discharging processes of individual batteries within the battery module.

As shown in FIG. 3, where the X-axis signifies time and the Y-axis denotes battery cell voltage, the battery Cr reaches both charge termination and discharge termination ahead of the batteries Cn. Consequently, the battery Cr is identified as the battery that requires replacement, and does not need recharging; the batteries Cn are designated as the initial rechargeable batteries.

In the method for recharging the battery module of the present embodiment, by obtaining the historical charging and discharging parameters corresponding to each battery within the battery module, which batteries need to be recharged and which batteries need to be replaced are determined based on the historical charging and discharging parameters of the individual batteries, thereby accurately identifying the initial rechargeable batteries.

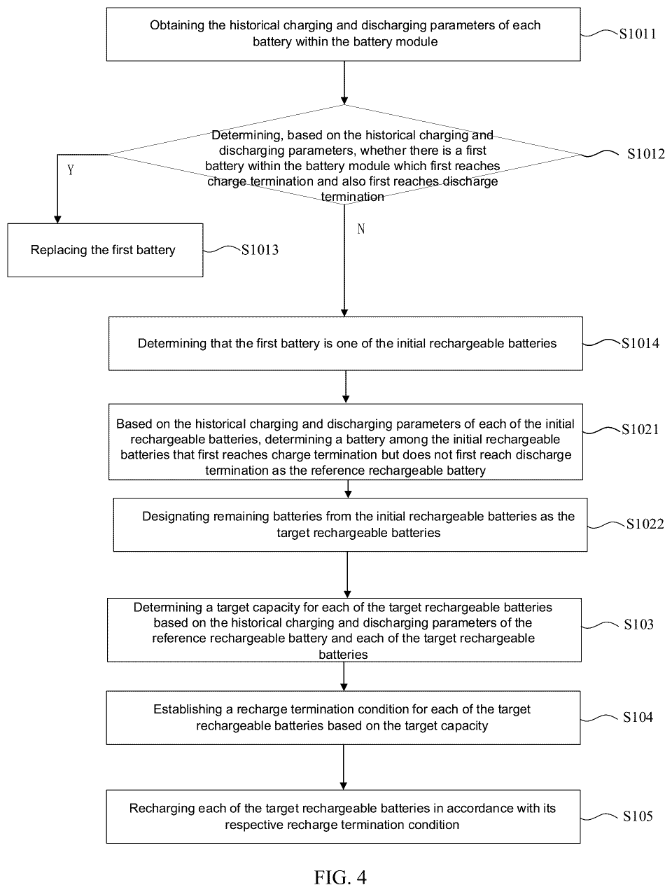

As an example, as shown in FIG. 4, step S102 comprises:
S1021: based on the historical charging and discharging parameters of each of the initial rechargeable batteries, determining a battery among the initial rechargeable batteries that first reaches charge termination but does not first reach discharge termination as the reference rechargeable battery.
S1022, designating remaining batteries from the initial rechargeable batteries as the target rechargeable batteries;

The preset charging and discharging conditions comprise the one first reaching charge termination without first reaching discharge termination, this battery is among the initial rechargeable batteries within the battery module, the battery that first reaches charge termination but does not first reach discharge termination is determined to be the reference rechargeable battery.

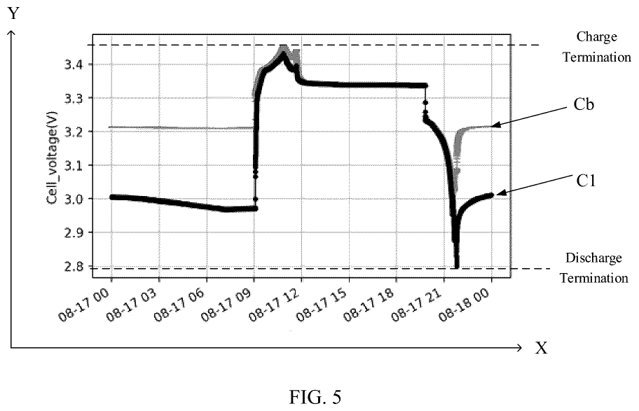

FIG. 5 shows a first chart for the historical charge and discharge parameters of the initial rechargeable batteries according to Embodiment 1, these cell voltage-vs-time data points reveal charging and discharging processes of the initial rechargeable batteries.

As shown in FIG. 5, where the X-axis signifies time and the Y-axis denotes battery voltage, the battery Cb reaches charge termination ahead of the batteries C1, but does not reach discharge termination ahead of the batteries C1, and thus the battery Cb is the reference rechargeable battery, and the batteries C1 is one of the target rechargeable batteries.

After the recharge reference battery is determined, the target capacity for each of the target rechargeable batteries relative to the reference rechargeable battery is obtained using the reference rechargeable battery as a reference.

Herein, when a battery reaches charge termination, it may be in a full-charge state, 80% fully charged, 85% fully charged, 90% fully charged, 95% fully charged, or any other state that approximates the full-charge state; and when a battery reaches discharge termination, it may be in a full-discharge state, 80% fully discharged, 85% fully discharged, 90% fully discharged, 95% fully discharged, or any other state that approximates the full-discharge state.

The present disclosed method accurately selects a reference rechargeable battery from a number of initial rechargeable batteries based on historical charging and discharging parameters of each of the initial rechargeable batteries, which in turn facilitates obtaining a target capacity of each of the target rechargeable batteries relative to the reference rechargeable battery by using the reference rechargeable battery as a reference, and then deriving the respective recharge termination condition of each of the target rechargeable batteries. By taking into account the unique conditions of each battery, the present disclosed method can individualize the settings for the recharge termination condition. The present disclosed method optimizes the recharging strategy, reducing the time needed for recharging the battery module. Moreover, it enhances the capacity of the battery module after the equalization recharging, maximizing its capacity and improving the efficiency of the operation and maintenance of the power station.

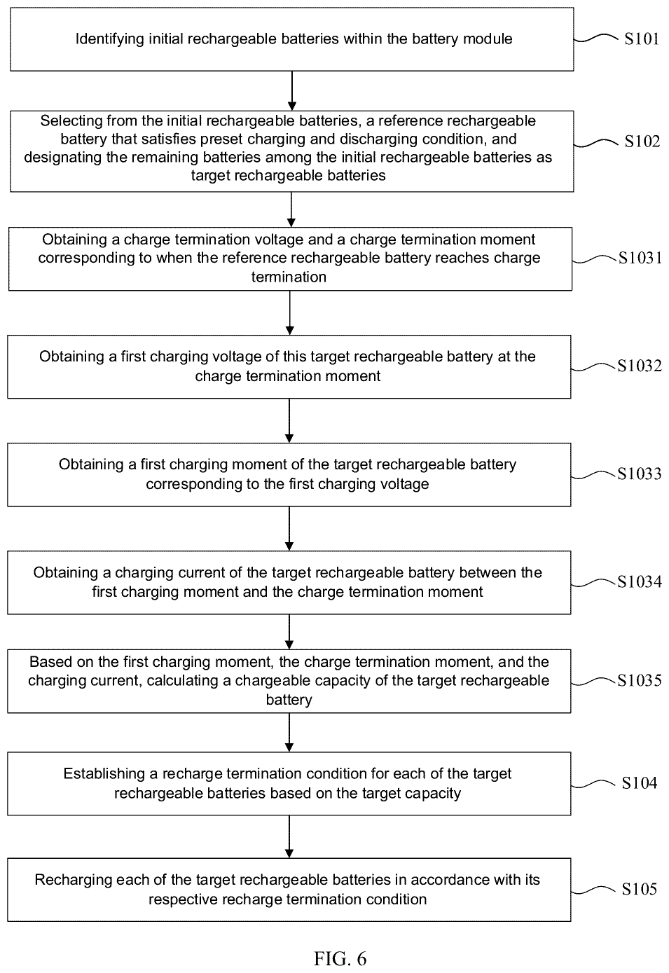

As an example, for each of the target rechargeable batteries, when the target capacity comprises a chargeable capacity, as shown in FIG. 6, step S103 comprises:
S1031: obtaining a charge termination voltage and a charge termination moment corresponding to when the reference rechargeable battery reaches charge termination;
S1032: obtaining a first charging voltage of this target rechargeable battery at the charge termination moment;
S1033: obtaining a first charging moment of the target rechargeable battery corresponding to the first charging voltage;
S1034: obtaining a charging current of the target rechargeable battery between the first charging moment and the charge termination moment;
S1035: based on the first charging moment, the charge termination moment, and the charging current, calculating a chargeable capacity of the target rechargeable battery.

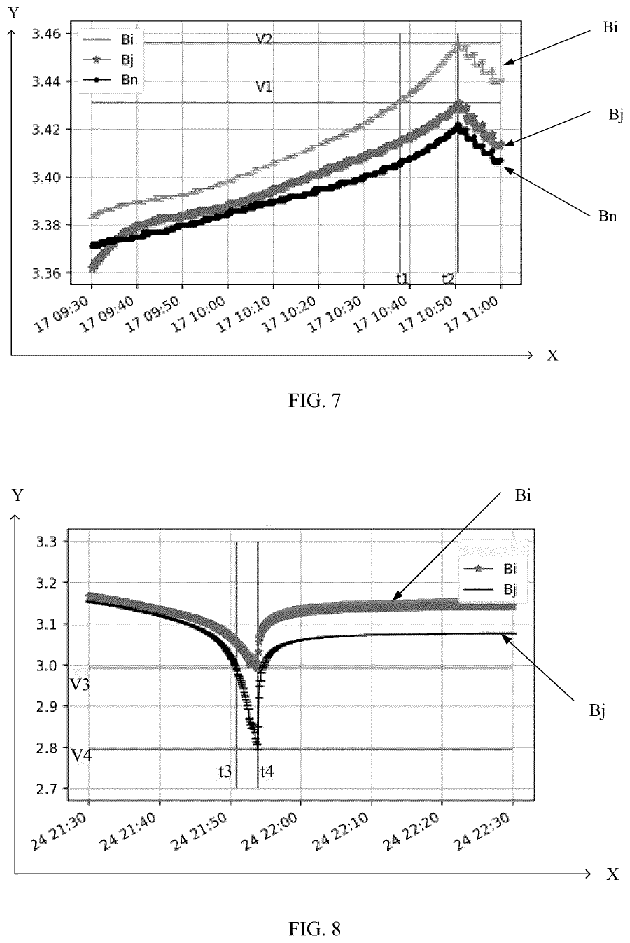

FIG. 7 shows a second chart for the historical charge and discharge parameters of the initial rechargeable batteries according to Embodiment 1, these cell voltage-vs-time data points reveal charging processes of the initial rechargeable batteries.

As shown in FIG. 7, the battery Bi is the reference rechargeable battery, the battery Bj and the battery Bn are target rechargeable batteries, V2 is the charge termination voltage of the reference rechargeable battery Bi when it reaches charge termination, and t2 is the charge termination moment corresponding to when the reference rechargeable battery Bi reaches charge termination; and V1 is the first charging voltage of the target rechargeable battery Bj at the charge termination moment t2, and t1 is the first charging moment corresponding to when the reference rechargeable battery Bi reaches the first charging voltage V1.

It can be seen that V1 is less than V2; the chargeable capacity of the target rechargeable battery Bj relative to the reference rechargeable battery Bi is the integral of currents from the moment t1 to the moment t2, i.e., the chargeable capacity of the target rechargeable battery is given by:

Qc=∫ₜ₁^{t2}Idt≈Σₖ₌₁ⁿΔtₖIₖ

Qc denotes the chargeable capacity of the target rechargeable battery, t1 denotes the first charging moment, t2 denotes the charge termination moment, I denotes the charging current, wherein a first total time interval between t1 and t2 is discretized into n portions based on a first sampling frequency, wherein Iₖ denotes the charging current corresponding to a kth portion, and Δtₖ denotes a first subsidiary time interval corresponding to the kth portion; the charging current may fluctuate across different time intervals; the chargeable capacity of the reference rechargeable battery, which is used as a reference for calculation, is 0.

According to the above formula for calculating the chargeable capacity, the chargeable capacity of the target rechargeable battery Bj relative to the reference rechargeable battery Bi is calculated.

Similarly, the chargeable capacity of other target rechargeable batteries Bn relative to the reference rechargeable battery Bi can be calculated, and the first charging moment and the first charging voltage corresponding to different target rechargeable batteries may be different, i.e., n, Δtₖ and Iₖ may be different, and the calculation is carried out according to the historical charging and discharging parameters of each of the target rechargeable batteries in conjunction with the formula for calculating the chargeable capacity described above.

In the present disclosed method for recharging the battery module, the target capacity comprises the chargeable capacity, and according to the historical charging and discharging parameters of the reference rechargeable battery and the target rechargeable batteries, the chargeable capacity of each of the target rechargeable batteries relative to the reference rechargeable battery is accurately calculated, from which the recharge termination condition corresponding to each of the target rechargeable batteries can be derived. By taking into account the unique conditions of each battery, the present disclosed method can individualize the settings for the recharge termination condition. The present disclosed method optimizes the recharging strategy, reducing the time needed for recharging the battery module. Moreover, it enhances the capacity of the battery module after the equalization recharging, maximizing its capacity and improving the efficiency of the operation and maintenance of the power station.

As an example, for each of the target rechargeable batteries, when the target capacity comprises a dischargeable capacity, step S103 further comprises:
S1036: obtaining a discharge termination voltage and a discharge termination moment corresponding to when this target rechargeable battery reaches discharge termination;
S1037: obtaining a first discharge voltage of the reference rechargeable battery at the discharge termination moment;
S1038: determining whether the discharge termination voltage is greater than the first discharge voltage;
if not, step S1039 is performed; if yes, the dischargeable capacity of this target rechargeable battery is determined to be 0.
S1039: obtaining a first discharge moment of the target rechargeable battery corresponding to the first discharge voltage;
S10310: obtaining a discharge current of the target rechargeable battery between the first discharge moment and the discharge termination moment;
S10311: based on the first discharge moment, the discharge termination moment, and the discharge current, calculating the dischargeable capacity of the target rechargeable battery.

FIG. 8 shows a third chart for the historical charge and discharge parameters of the initial rechargeable batteries according to Embodiment 1, these cell voltage-vs-time data points reveal discharging processes of the initial rechargeable batteries.

As shown in FIG. 8, the battery Bi is the reference rechargeable battery, the battery Bj is a target rechargeable battery, V4 is the discharge termination voltage of the target rechargeable battery Bj when it reaches discharge termination, and t4 is the discharge termination moment corresponding to when the target rechargeable battery Bj reaches discharge termination; V3 is the first discharge voltage of Bj corresponding to the reference rechargeable battery Bi at the discharge termination moment t4, and t3 is the discharge termination moment corresponding to when target rechargeable battery Bj reaches the first discharge voltage V3.

If V4 is greater than V3, the dischargeable capacity of the target rechargeable battery Bj relative to the reference rechargeable battery Bi is 0.

If V4 is less than V3, the dischargeable capacity of the target rechargeable battery Bj relative to the reference rechargeable battery Bi is the integral of currents from the moment t3 to the moment t4, i.e., the dischargeable capacity of the target rechargeable battery is given by:

Qd=∫ₜ₃^{t4}I′dt≈Σ_{f=1}^{m}Δt_{f}I_{f}

Qd denotes the dischargeable capacity of the target rechargeable battery, t3 denotes the first discharge moment, t4 denotes the discharge termination moment, I′ denotes the discharge current, wherein a second total time interval between t3 and t4 is discretized into m portions according to a second sampling frequency, I_{f} denotes the discharge current corresponding to a fth portion, and Δt_{f} denotes a second subsidiary time interval corresponding to the fth portion. The discharge current may vary across time intervals.

According to the above formula for calculating the dischargeable capacity, the dischargeable capacity of the target rechargeable battery Bj relative to the reference rechargeable battery Bi is calculated.

Similarly, the dischargeable capacity of the other target rechargeable batteries Bn relative to the reference rechargeable battery Bi may be calculated, and the first discharge moment and the first discharge voltage corresponding to different target rechargeable batteries may be different, i.e., m, Δt_{f} and I_{f} may be different, and the calculation is carried out according to the historical charging and discharging parameters of each of the target rechargeable batteries in conjunction with the formula for calculating the dischargeable capacity as described above.

In the present disclosed method for recharging the battery module, the target capacity comprises the dischargeable capacity, and according to the historical charging and discharging parameters of the reference rechargeable battery and the target rechargeable batteries, the dischargeable capacity of each of the target rechargeable batteries relative to the reference rechargeable battery is accurately calculated, from which the recharge termination condition corresponding to each of the target rechargeable batteries can be derived. By taking into account the unique conditions of each battery, the present disclosed method can individualize the settings for the recharge termination condition. The present disclosed method optimizes the recharging strategy, reducing the time needed for recharging the battery module. Moreover, it enhances the capacity of the battery module after the equalization recharging, maximizing its capacity and improving the efficiency of the operation and maintenance of the power station.

As an example, step S104 comprises:
S1041: determining whether the dischargeable capacity of the target rechargeable battery is less than or equal to the chargeable capacity of the same target rechargeable battery;
if yes, step S1042 is performed; if not, step S1043 is performed.
S1042: setting the chargeable capacity of the target rechargeable battery as the recharge termination condition of the target rechargeable battery;
S1043: setting the charge termination voltage as the recharge termination condition of the target rechargeable battery.

Take the target rechargeable battery Bj as an example, if the dischargeable capacity Qd of Bj is less than or equal to the chargeable capacity Qc of Bj, it means that the relative capacity of the target rechargeable battery Bj is large, and there is no need to recharge it to the charge termination voltage corresponding to charge termination, and the chargeable capacity Qc of the target rechargeable battery Bj is used as its recharge termination condition.

If the dischargeable capacity Qd of Bj is greater than the chargeable capacity Qc of Bj, it means that the relative capacity of the target rechargeable battery Bj is small, and it is necessary to recharge it to the charge termination voltage corresponding to charge termination, which is used as the recharge termination condition in this case.

The present disclosed method for recharging the battery module derives the recharge termination condition for each of the target rechargeable batteries by comparing the dischargeable capacity and the chargeable capacity of each of the target rechargeable batteries relative to the reference rechargeable battery. By taking into account the unique conditions of each battery, the present disclosed method can individualize the settings for the recharge termination condition. The present disclosed method optimizes the recharging strategy, reducing the time needed for recharging the battery module. Moreover, it enhances the capacity of the battery module after the equalization recharging, maximizing its capacity and improving the efficiency of the operation and maintenance of the power station.

### Embodiment 2

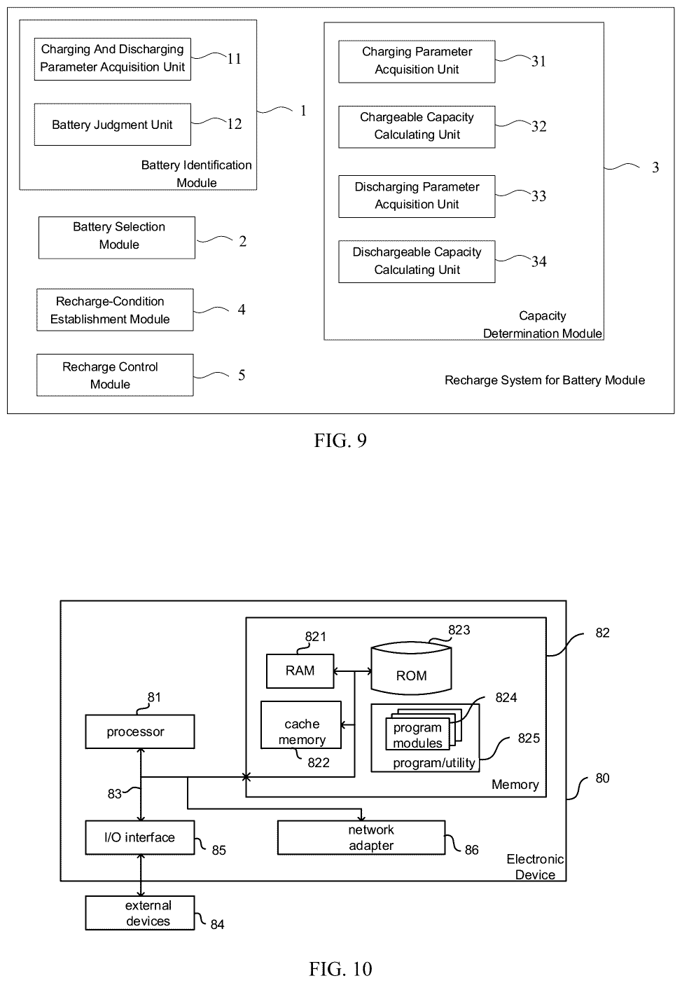

Embodiment 2 provides a system for recharging a battery module; as shown in FIG. 9, the system comprises: a battery identification module 1, for identifying initial rechargeable batteries within the battery module; a battery selection module 2, for selecting from the initial rechargeable batteries, a reference rechargeable battery that satisfies preset charging and discharging conditions, and designating remaining batteries of the initial rechargeable batteries as target rechargeable batteries; a capacity determination module 3, for determining a target capacity for each of the target rechargeable batteries based on the historical charging and discharging parameters of the reference rechargeable battery and each of the target rechargeable batteries; a recharge-condition establishment module 4, for establishing a recharge termination condition for each of the target rechargeable batteries based on the target capacity; and a recharge control module 5, for recharging each of the target rechargeable batteries in accordance with its respective recharge termination condition.

As an example, the battery identification module 1 comprises a charging and discharging parameter acquisition unit 11 for acquiring historical charging and discharging parameters corresponding to each battery within the battery module; a battery judgment unit 12 for determining, based on the historical charging and discharging parameters, whether the battery within a battery module that first reaches charge termination also first reaches discharge termination; if so, replacing this battery; if not, determining that this battery is one of the initial rechargeable batteries.

As an example, the battery selection module 2 determines a battery among the initial rechargeable batteries that first reaches charge termination but does not first reach discharge termination as the reference rechargeable battery, based on the historical charging and discharging parameters of each of the initial rechargeable batteries.

As an example, for each of the target rechargeable batteries, when the target capacity comprises a chargeable capacity, the capacity determination module 3 comprises a charging parameter acquisition unit 31, for obtaining a charge termination voltage and a charge termination moment corresponding to when the reference rechargeable battery reaches charge termination; obtaining a first charging voltage of this target rechargeable battery at the charge termination moment; obtaining a first charging moment of the target rechargeable battery corresponding to the first charging voltage; obtaining a charging current of the target rechargeable battery between the first charging moment and the charge termination moment; a chargeable capacity calculating unit 32, for calculating a chargeable capacity of the target rechargeable battery, based on the first charging moment, the charge termination moment, and the charging current.

As an example, for each of the target rechargeable batteries, when the target capacity comprises a dischargeable capacity, the capacity determination module 3 comprises a discharging parameter acquisition unit 33, for obtaining a discharge termination voltage and a discharge termination moment corresponding to when this target rechargeable battery reaches discharge termination; obtaining a first discharge voltage of the reference rechargeable battery at the discharge termination moment; determining whether the discharge termination voltage is greater than the first discharge voltage; if not, obtaining a first discharge moment of the target rechargeable battery corresponding to the first discharge voltage; obtaining a discharge current of the target rechargeable battery between the first discharge moment and the discharge termination moment; a dischargeable capacity calculating unit 34, for calculating the dischargeable capacity of the target rechargeable battery, based on the first discharge moment, the discharge termination moment, and the discharge current.

As an example, the chargeable capacity of the target rechargeable battery is given by:

Qc=∫ₜ₁^{t2}Idt≈Σₖ₌₁ⁿΔtₖIₖ

Qc denotes the chargeable capacity of the target rechargeable battery, t1 denotes the first charging moment, t2 denotes the charge termination moment, I denotes the charging current, wherein a first total time interval between t1 and t2 is discretized into n portions based on a first sampling frequency, wherein Iₖ denotes the charging current corresponding to a kth portion, and Δtₖ denotes a first subsidiary time interval corresponding to the kth portion; the charging current may fluctuate across different time intervals; the chargeable capacity of the reference rechargeable battery, which is used as a reference for calculation, is 0.

As an example, the dischargeable capacity of the target rechargeable battery is given by:

Qd=∫ₜ₃^{t4}I′dt≈Σ_{f=1}^{m}Δt_{f}I_{f}

Qd denotes the dischargeable capacity of the target rechargeable battery, t3 denotes the first discharge moment, t4 denotes the discharge termination moment, I′ denotes the discharge current, wherein a second total time interval between t3 and t4 is discretized into m portions according to a second sampling frequency, I_{f} denotes the discharge current corresponding to a fth portion, and Δt_{f} denotes a second subsidiary time interval corresponding to the fth portion. The discharge current may vary across time intervals.

As an example, the recharge-condition establishment module 4 is for: determining whether the dischargeable capacity of the target rechargeable battery is less than or equal to the chargeable capacity of the same target rechargeable battery; if yes, setting the chargeable capacity of the target rechargeable battery as the recharge termination condition of the target rechargeable battery; if not, setting the charge termination voltage as the recharge termination condition of the target rechargeable battery.

As an example, charge termination comprises a full-charge state and the discharge termination comprises a full-discharge state.

The principle of realizing the system for recharging the battery module is similar to that of the method for recharging the battery module of Embodiment 1.

The present disclosed system for recharging a battery module work by selecting a reference rechargeable battery and target rechargeable batteries from a battery module, obtaining a target capacity corresponding to each of the target rechargeable batteries based on historical charging and discharging parameters of the reference rechargeable battery and the target rechargeable batteries, and then deriving a recharge termination condition corresponding to each of the target rechargeable batteries. By considering the unique conditions of each battery, the present disclosed method can individualize the settings for the recharge termination condition. The present disclosed method optimizes the recharging strategy, reducing the time needed for recharging the battery module. Moreover, it enhances the capacity of the battery module after the equalization recharging, maximizing its capacity and improving the efficiency of the operation and maintenance of the power station.

### Embodiment 3

Embodiment 3 provides an electronic device, and FIG. 10 is a block diagram of the electronic device according to Embodiment 3. The electronic device comprises a memory, a processor, and a computer program stored on the memory and executable by the processor, and the processor executes the computer program to implement the method for recharging the battery module as described in Embodiment 1. The electronic device 80 shown in FIG. 10 is an illustrative example and is not intended to restrict the functionality and scope of use of embodiments of the present disclosure.

As shown in FIG. 10, the electronic device 80 may exist in the form of a general-purpose computing device; for example, it may be a computer server, or part of a computer server. Components of the electronic device 80 may comprise, but are not limited to: at least one processor 81 as described above, at least one memory 82 as described above, and a bus 83 connecting system components (including the memory 82 and the processor 81).

The bus 83 comprises a data bus, an address bus, and a control bus.

The memory 82 may comprise volatile memory, such as random access memory (RAM) 821 and/or cache memory 822, and may further comprise read-only memory (ROM) 823.

The memory 82 may also comprise a program/utility 825 containing one or more program modules 824; the program modules 824 comprise: an operating system, one or more applications, other program modules, and program data, and each of these examples, or some combination thereof, may incorporate an implementation of a networked environment.

The processor 81 performs various functional applications as well as data processing by executing computer programs stored in the memory 82, such as the method for recharging the battery module as described in Embodiment 1.

The electronic device 80 may also communicate with one or more external devices 84 (e.g., keyboards, pointing devices, etc.). Such communication may be carried out via an input/output (I/O) interface 85. And, the electronic device 80 may also communicate with one or more networks (e.g., a local area network (LAN), a wide area network (WAN), and/or a public network, such as the Internet) via a network adapter 86. As shown in FIG. 10, the network adapter 86 communicates with other modules of the electronic device 80 via the bus 83. It should be appreciated that, although not shown in the figures, other hardware and/or software modules may be used in conjunction with the electronic device 80, such modules comprise microcode, device drivers, redundant processors, external disk drive arrays, redundant arrays of independent disks (RAID) systems, tape drives, and data backup storage systems.

It should be noted that although a number of units/modules or sub-units/modules of the electronic device are referred to in the detailed description above, such a division is merely exemplary not mandatory. According to embodiments of the present disclosure, the features and functions of two or more units/modules described above may be implemented by a single unit/module. Conversely, the features and functions of one unit/module described above may be further divided and implemented by several units/modules.

### Embodiment 4

Embodiment 4 provides a computer-readable storage medium on which a computer program is stored, wherein when executed by a processor, the computer program implements the method for recharging the battery module as described in Embodiment 1.

Wherein the computer-readable storage medium may comprise one or more of a portable disk, a hard disk, a RAM, a ROM, an erasable programmable ROM, an optical storage device, and a magnetic storage device.

In possible embodiments, the present disclosure may also be realized in the form of a program product comprising program code, wherein when the program product is executed on a terminal device, the program code is used to cause the terminal device to perform steps of the method for recharging the battery module as described in Embodiment 1.

The program code for executing the present disclosure may be written in one or more programming languages, and the program code may be executed entirely on a user device, partially on the user device, as a stand-alone software package, partially on the user device partially on the remote device, or entirely on a remote device.

While specific embodiments of the present disclosure are described above, it should be understood by those skilled in the art that the described embodiments are illustrative and not restrictive. Those skilled in the art may make a variety of changes or modifications to these embodiments without departing from the principles and substance of the present disclosure, and these changes and modifications also fall within the scope of the present disclosure.

What is claimed is:

1. A method for recharging a battery module, comprising:
identifying initial rechargeable batteries within the battery module;
selecting, from the initial rechargeable batteries, a reference rechargeable battery that satisfies preset charging and discharging conditions, and designating remaining batteries of the initial rechargeable batteries as target rechargeable batteries;
determining a target capacity for each of the target rechargeable batteries based on historical charging and discharging parameters of the reference rechargeable battery and each of the target rechargeable batteries;
establishing a recharge termination condition for each of the target rechargeable batteries based on its respective target capacity; and
recharging each of the target rechargeable batteries in accordance with its respective recharge termination condition.

2. The method according to claim 1, wherein identifying the initial rechargeable batteries within the battery module comprises:
obtaining the historical charging and discharging parameters of each battery within the battery module; and
determining, based on the historical charging and discharging parameters, whether there is a first battery within the battery module which first reaches charge termination and also first reaches discharge termination;
if yes, replacing the first battery;
if not, determining that the first battery is one of the initial rechargeable batteries.

3. The method according to claim 2, wherein selecting from the initial rechargeable batteries, the reference rechargeable battery, comprises:
based on the historical charging and discharging parameters of each of the initial rechargeable batteries, determining on a battery among the initial rechargeable batteries that if the battery first reaches charge termination but does not first reach discharge termination and designating the battery as the reference rechargeable battery.

4. The method according to claim 1, wherein when the target capacity comprises a chargeable capacity, determining the target capacity for each of the target rechargeable batteries comprises:
obtaining a charge termination voltage and a charge termination moment corresponding to when the reference rechargeable battery reaches the charge termination;
obtaining a first charging voltage of the target rechargeable battery at the charge termination moment of the reference rechargeable battery;
obtaining a first charging moment of the target rechargeable battery corresponding to the first charging voltage;
obtaining a charging current of the target rechargeable battery between the first charging moment of the target rechargeable battery and the charge termination moment of the reference rechargeable battery; and
based on the first charging moment, the charge termination moment, and the charging current, calculating a chargeable capacity of the target rechargeable battery.

5. The method according to claim 4, wherein for each of the target rechargeable batteries, when the target capacity comprises a dischargeable capacity, determining the target capacity for each of the target rechargeable batteries comprises:
obtaining a discharge termination voltage and a discharge termination moment corresponding to when this target rechargeable battery reaches discharge termination;
obtaining a first discharge voltage of the reference rechargeable battery at the discharge termination moment;
determining whether the discharge termination voltage is greater than the first discharge voltage; if not, obtaining a first discharge moment of the target rechargeable battery corresponding to the first discharge voltage;
obtaining a discharge current of the target rechargeable battery between the first discharge moment and the discharge termination moment of the target rechargeable battery; and
based on the first discharge moment, the discharge termination moment, and the discharge current, calculating a dischargeable capacity of the target rechargeable battery.

6. The method according to claim 5, wherein the chargeable capacity of the target rechargeable battery is given by:
Qc=∫ₜ₁^{t2}Idt≈Σₖ₌₁ⁿΔtₖIₖ,
wherein Qc denotes the chargeable capacity of the target rechargeable battery, t1 denotes the first charging moment of the target rechargeable battery, t2 denotes the charge termination moment of the reference rechargeable battery, I denotes the charging current, wherein a first total time interval between t1 and t2 is discretized into n portions based on a first sampling frequency, wherein Iₖ denotes the charging current corresponding to a kth portion, and Δtₖ denotes a first subsidiary time interval corresponding to the kth portion;
wherein the dischargeable capacity of the target rechargeable battery is given by:
Qd=∫ₜ₃^{t4}I′dt≈Σ_{f=1}^{m}Δt_{f}I_{f},
wherein Qd denotes the dischargeable capacity of the target rechargeable battery, t3 denotes the first discharge moment, t4 denotes the discharge termination moment of the target rechargeable battery, I′ denotes the discharge current, and wherein a second total time interval between t3 and t4 is discretized into m portions according to a second sampling frequency, I_{f} denotes the discharge current corresponding to a fth portion, and Δt_{f} denotes a second subsidiary time interval corresponding to the fth portion.

7. The method according to claim 5, wherein establishing the recharge termination condition for each of the target rechargeable batteries based on the target capacity comprises:
determining whether the dischargeable capacity of the target rechargeable battery is less than or equal to the chargeable capacity of same target rechargeable battery;
if yes, setting the chargeable capacity of the target rechargeable battery as a recharge termination condition of the target rechargeable battery; and
if not, setting the charge termination voltage as the recharge termination condition of the target rechargeable battery.

8. The method according to claim 2, wherein the charge termination comprises a full-charge state and a discharge termination comprises a full-discharge state.

9. A recharge system for a battery module, wherein the recharge system comprises:
a battery identification module, for identifying initial rechargeable batteries within the battery module;
a battery selection module, for selecting, from the initial rechargeable batteries, a reference rechargeable battery that satisfies preset charging and discharging conditions, and for designating remaining batteries among the initial rechargeable batteries as target rechargeable batteries;
a capacity determination module, for determining a target capacity for each of the target rechargeable batteries based on historical charging and discharging parameters of the reference rechargeable battery and each of the target rechargeable batteries;
a recharge-condition establishment module, for establishing a recharge termination condition for each of the target rechargeable batteries based on the target capacity; and
a recharge control module, for recharging each of the target rechargeable batteries in accordance with its respective recharge termination condition.

10. An electronic device comprising a memory, a processor and a computer program stored on the memory and executable by the processor, wherein the processor executes the computer program to implement the method for recharging the battery module according to claim 1.

11. A non-transitory computer-readable storage medium, storing a computer program, wherein when the computer program is executed by a processor, the method for recharging the battery module according to claim 1 is implemented.
